(19) United States
(12) Patent Application Publication
(10) Pub. No.: US 2016/0208823 A1
(43) Pub. Date: Jul. 21, 2016

(54) SHROUDED FAN ROTOR

(71) Applicant: Hamilton Sundstrand Corporation, Windsor Locks, CT (US)

(72) Inventors: Eric Chrabascz, Longmeadow, MA (US); Dilip Prasad, North Granby, CT (US); Murtuza Lokhandwalla, South Windsor, CT (US); Harold W. Hipsky, Willington, CT (US)

(21) Appl. No.: 14/599,829

(22) Filed: Jan. 19, 2015

(51) Int. Cl. F04D 29/66; B64D 13/00; F04D 29/32; B64D 41/00; F04D 19/00; F04D 25/08

(52) U.S. Cl. CPC F04D 29/668; F04D 19/002; F04D 25/08; F04D 29/326; B64D 41/007; B64D 13/00

(57) ABSTRACT

A fan rotor for an aircraft environmental control system ram fan is provided. The fan rotor includes central body defining a central axis and a radius having a first radial distance that is defined as a distance from the central axis to an edge of the central body. A plurality of fan blades extend radially from the edge of the central body to a second radial distance, the second radial distance defined as a distance from the central axis to a tip of the fan blades. A shroud extends circumferentially between and connecting each of the plurality of fan blades. The shroud is located at a radial distance from the central axis that is greater than the first radial distance and includes one or more tuning features configured to mistune a vibration of the fan rotor during operation.

### BACKGROUND OF THE INVENTION

The subject matter disclosed herein generally relates to the field of fan rotors and more particularly to shrouded fan rotors.

The subject matter also generally relates to environmental control systems. In particular, the subject matter relates to a ram air fan assembly and fan rotors thereof for environmental control systems for aircraft.

An environmental control system (ECS) aboard an aircraft provides conditioned air to an aircraft cabin. Conditioned air is air at a temperature, pressure, and humidity desirable for aircraft passenger comfort and safety. At or near ground level, the ambient air temperature and/or humidity is often sufficiently high that the air must be cooled as part of the conditioning process before being delivered to the aircraft cabin. At flight altitude, ambient air is often far cooler than desired, but at such a low pressure that it must be compressed to an acceptable pressure as part of the conditioning process. Compressing ambient air at flight altitude heats the resulting pressurized air sufficiently that it must be cooled, even if the ambient air temperature is very low. Thus, under most conditions, heat must be removed from air by the ECS before the air is delivered to the aircraft cabin. As heat is removed from the air, it is dissipated by the ECS into a separate stream of air that flows into the ECS, across heat exchangers in the ECS, and out of the aircraft, carrying the excess heat with it. Under conditions where the aircraft is moving fast enough, the pressure of air ramming into the aircraft is sufficient to move enough air through the ECS and over the heat exchangers to remove the excess heat.

While ram air works well under normal flight conditions, at lower flight speeds, or when the aircraft is on the ground, ram air pressure may be too low to provide enough air flow across the heat exchangers for sufficient heat removal from the ECS. Under these conditions, a fan within the ECS is employed to provide the necessary airflow across the ECS heat exchangers. This fan is called a ram air fan.

### BRIEF DESCRIPTION OF THE INVENTION

According to one embodiment, a fan rotor for an aircraft environmental control system ram fan is provided. The fan rotor includes central body defining a central axis and a radius having a first radial distance that is defined as a distance from the central axis to an edge of the central body. A plurality of fan blades extend radially from the edge of the central body to a second radial distance, the second radial distance defined as a distance from the central axis to a tip of the fan blades. A shroud extends circumferentially between and connecting each of the plurality of fan blades. The shroud is located at a radial distance from the central axis that is greater than the first radial distance and includes one or more tuning features configured to mistune a vibration of the fan rotor during operation.

According to another embodiment, a method of manufacturing a fan rotor for an air cycle machine is provided. The method includes providing a material for a fan rotor, forming a central body of the fan rotor from the material, the central body defining a central axis and a radius having a first radial distance that is defined as a distance from the central axis to an edge of the central body, removing material to form a plurality of fan blades extending radially from the edge of the central body to a second radial distance defined as a distance from the central axis to a tip of the fan blades, forming a shroud that extends circumferentially between and connects each of the plurality of fan blades, the shroud located at a radial distance from the central axis that is greater than the first radial distance, and forming one or more tuning features in the shroud, the one or more tuning features configured to mistune a vibration of the fan rotor during operation.

Technical features of the invention include a ram air fan rotor having a shroud that provides improved structural stability and strength to the fan rotor such that failure or damage during surge events may be prevented.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic of a ram air fan unit of an aircraft that may employ embodiments of the invention;

FIG. 2 is a schematic view of a prior art fan rotor;

FIG. 3A is a schematic view of a fan rotor in accordance with an exemplary embodiment of the invention;

FIG. 3B is a schematic partial view of the fan rotor of FIG. 3A;

FIG. 3C is a schematic partial alternative view of the fan rotor of FIG. 3A;

FIG. 4 is a process of making a fan rotor in accordance with an exemplary embodiment of the invention.

### DETAILED DESCRIPTION OF THE INVENTION

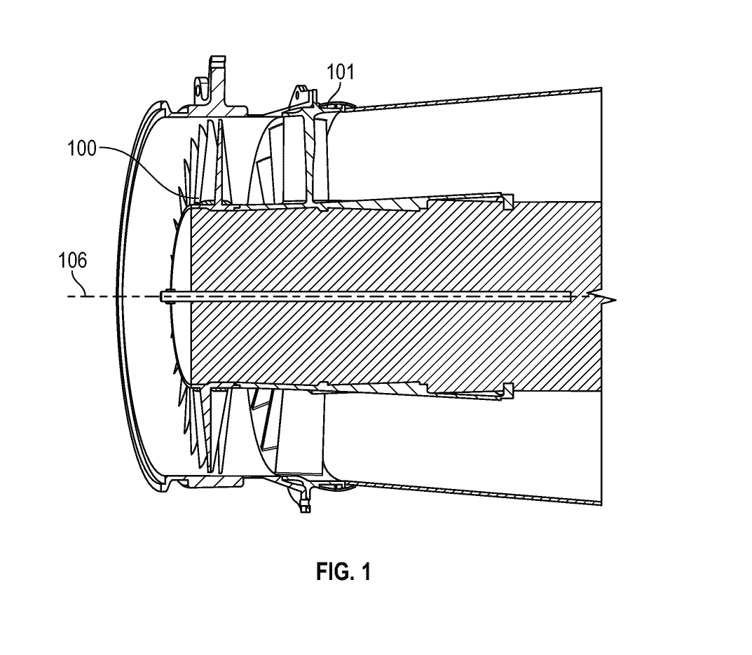

FIG. 1 shows a schematic of a ram air fan 101 having a fan rotor 100. Ram air fan 101 may be configured within an aircraft and used to expel heated air by operation of the fan rotor 100 spinning or rotating to form a fan flow that passes through the ram air fan 101 and out of an aircraft. The fan rotor 100 is configured to rotate about an axis 106. The ram air fan 101 may be configured as part of an air cycle machine and/or part of an environmental control system of an aircraft. The environmental control system may be pneumatic or electric driven.

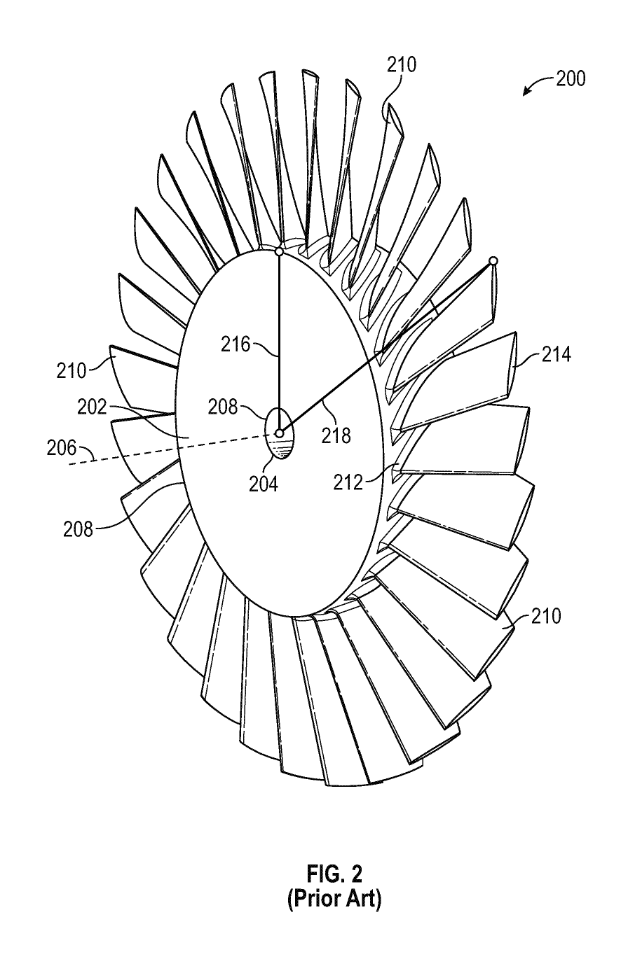

Turning now to FIG. 2, a schematic view of a traditional fan rotor 200 is shown. Fan rotor 200 is formed of a substantially circular central body 202 having an aperture 204 therethrough centered about a central axis 206 and having an edge 208. A plurality of fan blades 210 are configured to extend radially from the edge 208, starting at a base 212 and extending to a free end or tip 214. Central body 202 is configured to be mounted on a rotatable shaft (not shown) or operationally connected to other rotatable elements (not shown) through aperture 204 and about a central axis 206, such as in ram air fan 101 of FIG. 1.

A first radial distance 216 is defined as the radial distance from the central axis 206 of fan rotor 200 to the edge 208 of the central body. Thus, the central body 202 generally defines a circular or disk shape with a radius of 216. A second radial distance 218 is defined as the radial distance from the central axis 206 to the blade tip 214. Thus, the length of the fan blades 210 is the second distance minus the first distance.

Although fan rotor 200 may be configured to operate as a ram air fan for an aircraft environmental control system, such as that shown in FIG. 1; those of skill in the art will appreciate that the fan rotor 200 can be configured to operate in other devices. The fan rotor 200 is relatively simple to manufacture and has been widely used in the aircraft industry.

As noted, the fan blades 210 have free ends at tips 214, and thus the end of the blades are free floating and may be subject to vibrations and stresses. For example, due to operational stresses, the fan blades 210 may fail during a surge event. A surge event may occur when there is a blockage upstream of the fan within the system, such as in a partially blocked heat exchanger in an environmental control system of an aircraft, which may result in increased stresses within the system. Thus, the stresses imposed on the fan rotor 200 are increased, and specifically the stresses imposed on the fan blades 210 are increased, which can result in failure, damage, or breaking of the fan blades 210.

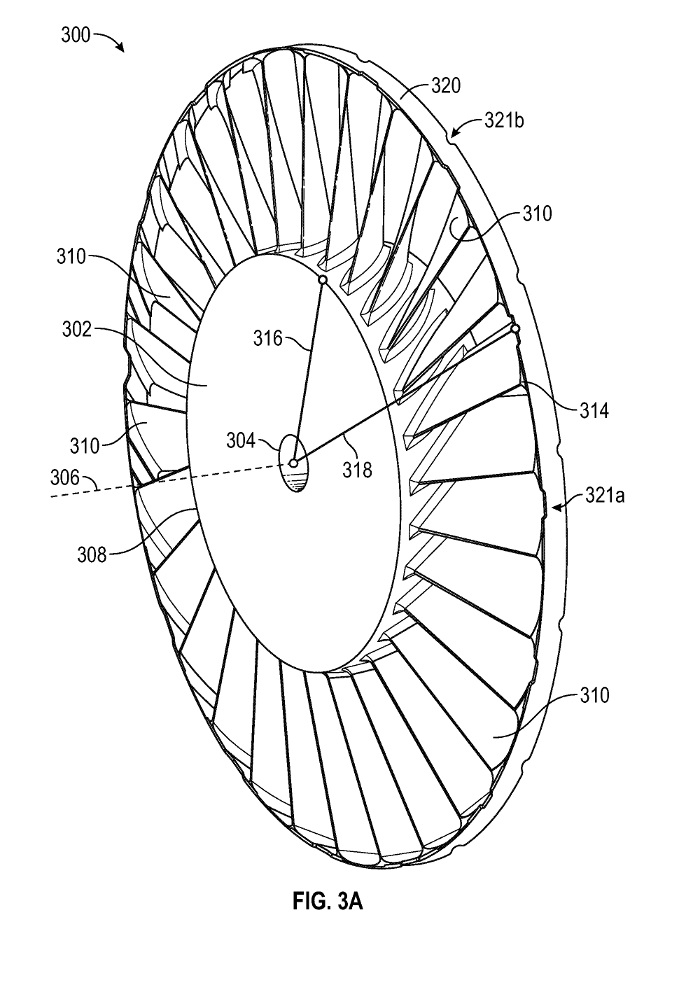

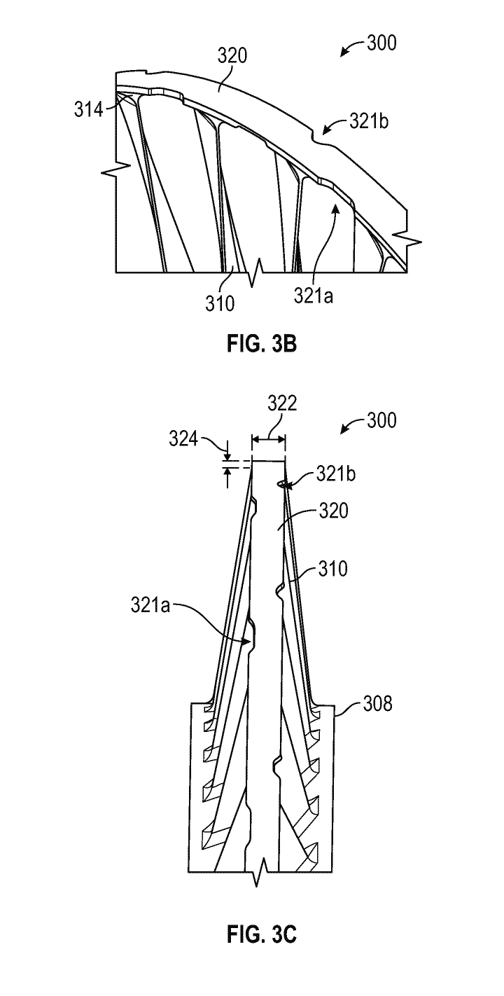

Turning now to FIGS. 3A, 3B, and 3C, a fan rotor 300 in accordance with an exemplary embodiment of the invention is shown. As shown in FIG. 3A, fan rotor 300 has a similar configuration as fan rotor 200 of FIG. 2, thus similar features are presented with similar reference numbers but preceded by a “3” rather than a “2.” Thus, fan rotor 300 includes a substantially circular central body 302 with a plurality of fan blades 310 extending radially from an edge 308 thereof In the embodiment of FIGS. 3A-3C, in contrast to the fan rotor 200 of FIG. 2, fan rotor 300 includes a shroud 320 that extends circumferentially around the fan rotor 300 and connects each of the fan blades 310. For example, the shroud 320 may be formed of the same material as the fan blades 310 and rigidly connect each of the fan blades 310. In some embodiments, fan rotor 300, and other configurations/embodiments, may be employed as ram fans for environmental control systems of aircraft, and may compose fan rotors for air cycle machines and/or electric powered ram fans, for example.

Shroud 320, as shown in FIG. 3A, is located at a distance 318 from the central axis 306. That is, as shown, shroud 320 is located at the tips 314 of the blades 310, and thus rigidly connects each tip 314 of each blade 310 of fan rotor 300. However, those of skill in the art will appreciate that the radial location of the shroud 320 is not required to be located at the radial distance 318. For example, in some embodiments, the shroud 320 may be located at a third distance that is any radial distance between the first distance 316 and the second distance 318 and extend circumferentially around the fan rotor 300 such that each blade 310 of the fan rotor 300 is connected.

Further, in some embodiments, the shroud 320 does not need to be uniform in its construction and/or configuration. For example, as shown in FIGS. 3A-3C, the shroud 320 may include one or more impeller tuning features 321a, 321b. The impeller tuning features 321a, 321b, as shown in FIGS. 3A-3C are configured as indents or removed material from the axial profile of the shroud 320. Such features may be provided in a repeating pattern or may be configured in other ways. For example, as shown, the impeller tuning features 321a, 321b may be formed on both sides (axially) of the shroud 320. The tuning feature(s) 321a, 321b enable various parts of the axial thickness of the shroud 320 may be varied. This variance in axial thickness may lead to a mistuning of the fan rotor 300 during operation. Specifically, an asymmetry of the axial thickness of the shroud 320 can ensure that the vibrations of each of the fan blades 310 do not ring in unison, and thus prevent the fan rotor 300 from vibrating at a single frequency.

In the example of FIGS. 3A-3C, the tuning feature 321a is larger circumferentially than the tuning feature 321b. The configuration, shape, dimension, geometry, thickness, etc. of the tuning features may be optimized for a particular application, and the invention is not limited thereby. For example, the tuning features may: all be similar or identical; located on only one axial side of the rotor; vary radially in thickness; form aerodynamic shapes; extend axially as protrusions; etc. As such, those of skill in the art will appreciate that the tuning features of the invention are not limited by the present description.

As another example, the radial thickness of the tuning feature of the shroud may be varied, depending on the requirements of use or engineering. A thicker shroud, whether thicker in a radial or axial direction, will provide more material and thus rigidity between the fan blades. However, the additional material will add more weight to the fan rotor, and thus a trade-off may be made depending on the design and needs of the particular fan rotor. In some embodiments, the radial and/or axial thickness of the shroud may be varied to form the tuning feature. In some embodiments that include a varying axial thickness, the tuning feature may be formed with an undulating form or contour along the circumference of the shroud. In some embodiments the contour or shape of the tuning feature may be configured with a repeating pattern or wave pattern. For example, the tuning feature may be formed as a wave pattern or frequency around the circumference of the shroud with the pattern of frequency defining the axial thickness of the shroud.

For example, with reference to FIG. 3C, shroud 320 is shown with a radial position at distance 318 and having an axial thickness of 322. The axial thickness 322, as shown in FIG. 3C, is a substantially uniform thickness at points not having a tuning feature 321a, 321b and, at this uniform thickness, is configured to be the axial length of the blade tip 314 at the outer-most edge. The radial thickness 324 may also be substantially uniform in thickness throughout the circumference of shroud 320. However, as noted, various alternative embodiments may have varying thicknesses at various points, in the radial thickness and/or the axial thickness. In some embodiments, the radial thickness 324 of shroud 320 may be about 0.1 inches on an about 9.0 inch rotor fan 300, i.e., the second distance 218 may be about 9.0 inches. In some embodiments with a varying thickness, the shroud may have a radial thickness, for example, ranging from about 0.040 inches to about 0.400 inches.

Advantageously, in embodiments that include a tuning feature with a frequency pattern formed in the shroud, either radially or axially, a mistuning of the fan rotor during operation may be provided. Specifically, an asymmetry of the thickness of the shroud can ensure that the vibrations of each of the fan blades do not ring in unison, and thus prevent the fan rotor from vibrating at a single frequency. It is advantageous to prevent vibration at a single frequency because such vibrations may result in additional stress on and/or failure of the blades. The single frequency is prevented, in part, because of an asymmetric distribution of weight around the fan rotor. Thus, while still providing structural strengthening by connecting each of the fan blades of the fan rotor, the variations in thicknesses can be configured to prevent undesirable frequency vibrations within the rotor and blades thereof

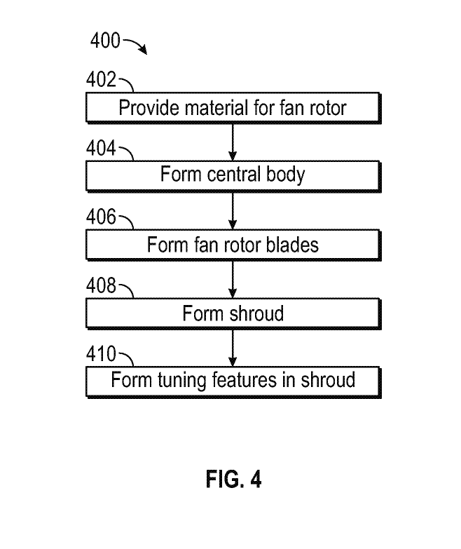

Turning now to FIG. 4, a process 400 for manufacturing a fan rotor in accordance with an exemplary embodiment of the invention is shown. At step 402 bar stock or similar stock is provided for milling, machining, forging, etc. At step 404 a central body is formed by the selected and/or desired processing, leaving formed central plate out to a first distance, as discussed above. Between the first distance and the second distance will be a solid sheet of material that must now be formed to form the blades of the fan rotor.

At step 406 material is removed, by known methods, from the stock between the first distance, defined as a distance from a central axis to the edge of the central body, and a second distance, defined as a distance from the central axis to the outer rim of the fan rotor, i.e., the fan blade tips, to form the fan blades. At step 408 a shroud is formed on the fan rotor. The shroud may be formed at the second distance (i.e., at the terminal edge of the fan blades), or at some third distance that is between the first distance and the second distance. At step 410, the shroud may be modified to have variable thicknesses in the radial, axial, and/or circumferential directions, i.e., to form one or more tuning features. Process 400 thus may form a fan rotor similar to that shown in FIGS. 3A-3C with a shroud connecting each of the fan blades, and a tuning feature formed as part of the shroud.

Although process 400 is described as a sequence of steps, those of skill in the art will appreciate that the order of steps is not restricted to that presented above. For example, the machining may all occur at once, and thus steps 404-410 may occur simultaneously, without departing from the scope of the invention. Further, in some embodiments, the steps may be performed in a different order as presented above, or various sub-combinations of steps may be performed simultaneously, without departing from the scope of the invention.

Advantageously, in accordance with various embodiments of the invention, a shrouded fan rotor can significantly reduce the cyclic stress during a surge event, thus prolonging the life of the fan rotor and reducing the need to service or perform maintenance thereon. Specifically, embodiments of the invention may provide a fan rotor that can survive surge events without damage being done to the fan rotor.

Furthermore, advantageously, providing a shroud increases the weight of the fan rotor and thus can push the frequency of modes of operation of the fan rotor out of fan operating speed ranges. For example, the addition of the shroud, due to the weight and the structural integrity, may enable a fan rotor to operate at higher speeds than traditional fan rotors.

Moreover, advantageously, in accordance with various embodiments of the invention, varying the construction of the shroud may provide additional and/or alternative advantages. For example, by providing a pattern of frequency in the shape of the shroud, either in terms of axially thickness or radial thickness, may enable a mistuning of the fan rotor to thus prevent the rotor from operating at specific frequencies that may enable damage to occur to the blades and/or the rotor fan.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments and/or features.

For example, although shown in FIGS. 3A-3C with the shroud located at the outer diameter of the fan rotor, those of skill in the art will appreciate that various embodiments may have the location of the shroud at a radial distance from the central axis that is less than the outer diameter, and still connect each of the blades. Further, although the process of forming a shrouded fan rotor in accordance with embodiments of the invention included forming the entire fan rotor from a single stock of material, this is merely an example, and the invention is not limited thereby. For example, each blade may be formed and welded or otherwise connected to a central body that is separate therefrom at the time of formation. Further, for example, the shroud may be welded to or otherwise connected to the blades of the fan rotor to provide similar advantages as described above, and still not depart from the scope of the invention.

Accordingly, the invention is not to be seen as limited by the foregoing description, but is only limited by the scope of the appended claims.

What is claimed is:

1. A fan rotor for an aircraft environmental control system ram fan comprising:
a central body defining a central axis and a radius having a first radial distance that is defined as a distance from the central axis to an edge of the central body;
a plurality of fan blades extending radially from the edge of the central body to a second radial distance, the second radial distance defined as a distance from the central axis to a tip of the fan blades; and
a shroud extending circumferentially between and connecting each of the plurality of fan blades, the shroud located at a radial distance from the central axis that is greater than the first radial distance,
wherein the shroud comprises one or more tuning features configured to mistune a vibration of the fan rotor during operation.

2. The fan rotor of claim 1, wherein the radial distance of the location of the shroud is equal to the second radial distance.

3. The fan rotor of claim 1, wherein the one or more tuning features define a varying radial thickness of the shroud around the circumferential extent of the shroud.

4. The fan rotor of claim 1, wherein the one or more tuning features define a varying axial thickness of the shroud around the circumferential extent of the shroud.

5. The fan rotor of claim 4, wherein the varying axial thickness around the circumferential extent of the shroud defines a repeating wave pattern of thicknesses.

6. The fan rotor of claim 1, wherein the shroud defines a thickness between about 0.040 inches and about 0.400 inches in the radial direction

7. The fan rotor of claim 1, wherein the central body is configured to operationally attach to a portion of an air cycle machine.

8. The fan rotor of claim 7, wherein the air cycle machine is part of an environmental control system of an aircraft.

9. A method of manufacturing a fan rotor for an air cycle machine, the method comprising:
providing a material for a fan rotor;
forming a central body of the fan rotor from the material, the central body defining a central axis and a radius having a first radial distance that is defined as a distance from the central axis to an edge of the central body;
removing material to form a plurality of fan blades extending radially from the edge of the central body to a second radial distance defined as a distance from the central axis to a tip of the fan blades;
forming a shroud that extends circumferentially between and connects each of the plurality of fan blades, the shroud located at a radial distance from the central axis that is greater than the first radial distance; and
forming one or more tuning features in the shroud, the one or more tuning features configured to mistune a vibration of the fan rotor during operation.

10. The method of claim 9, wherein the shroud is formed at a radial distance that is equal to second radial distance.

11. The method of claim 9, wherein the one or more tuning features are formed with a varying radial thickness around the circumferential extent of the shroud.

12. The method of claim 9, wherein the one or more tuning features are formed with a varying axial thickness around the circumferential extent of the shroud.

13. The fan rotor of claim 12, wherein the varying axial thickness around the circumferential extent of the shroud defines a repeating wave pattern of thicknesses.

14. The method of claim 9, wherein the shroud is formed with a thickness between about 0.040 inches and about 0.400 inches in the radial direction.

15. The method of claim 9, wherein the central body is formed to operationally attach to a portion of an air cycle machine.

16. The method of claim 9, further comprising installing the formed fan rotor into an environmental control system of an aircraft.
